(19) United States
(12) Patent Application Publication
(10) Pub. No.: US 2013/0113392 A1
(43) Pub. Date: May 9, 2013

(54) LUMINANT TILE ASSEMBLY

(71) Applicant: Hsu-Chih Chen, Taipei City (TW)

(72) Inventor: Hsu-Chih Chen, Taipei City (TW)

(21) Appl. No.: 13/288,966

(22) Filed: Nov. 4, 2011

(51) Int. Cl. H05B 37/02

(52) U.S. Cl. 315/294

(57) ABSTRACT

The luminant tile assembly contains a positioning seat, a luminant tile member configured on the positioning seat, and a control device electrically connected to the luminant tile member via the positioning seat. The luminant tile member contains a layered structure and a number of connectors for electrically connecting the positioning seat and the layered structure. The luminant tile assembly can be quickly and conveniently installed on and detached from a wall, floor, or ceiling where various and versatile lighting effects are provided.

### TECHNICAL FIELD OF THE INVENTION

The present invention is generally related to tiles, and more particular to a wall, floor, or ceiling tile assembly that is integrated with lighting elements.

### DESCRIPTION OF THE PRIOR ART

Currently, the exterior of most building is tiled by ceramic or stone tiles with decorative patterns, colors, or graphics.

Other than the enhanced appearance, these tiles do not provide additional function. On the other hand, the buildings are often separately installed with luminescent lamps, halogen lamps, or LED lamps for illumination. If the tiles can provide both decoration and illumination, the tiles would be more practical and valuable.

### SUMMARY OF THE INVENTION

A major objective of the present invention is to provide a luminant tile assembly for quick and convenient installation on and detachment from a wall, floor, or ceiling where various and versatile lighting effects can be provided.

To achieve the objective, the tile assembly contains a positioning seat, a luminant tile member configured on the positioning seat, and a control device electrically connected to the luminant tile member via the positioning seat. The luminant tile member contains a layered structure and a number of connectors for electrically connecting the positioning seat and the layered structure.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a luminant tile assembly according to an embodiment of the present invention.

FIG. 2 is a perspective break-down diagram showing the various components of the luminant tile assembly of FIG. 1.

FIG. 3 is a perspective diagram showing an installation scenario of the luminant tile assembly of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

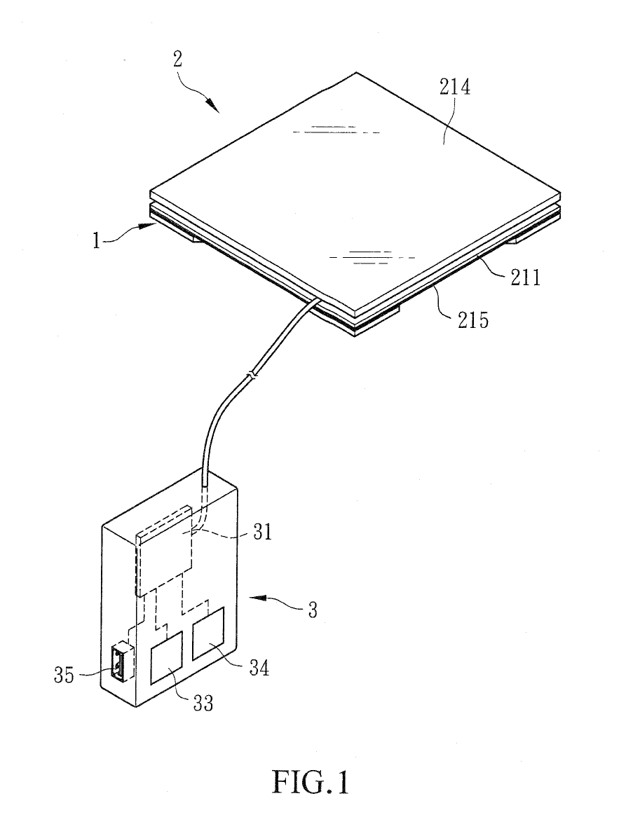

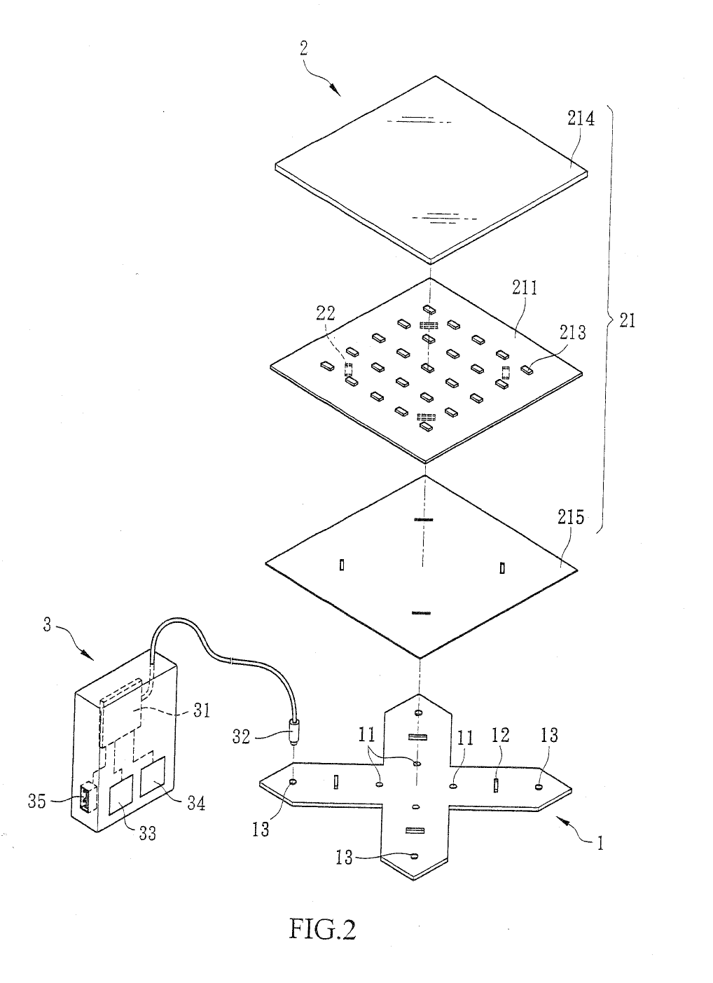

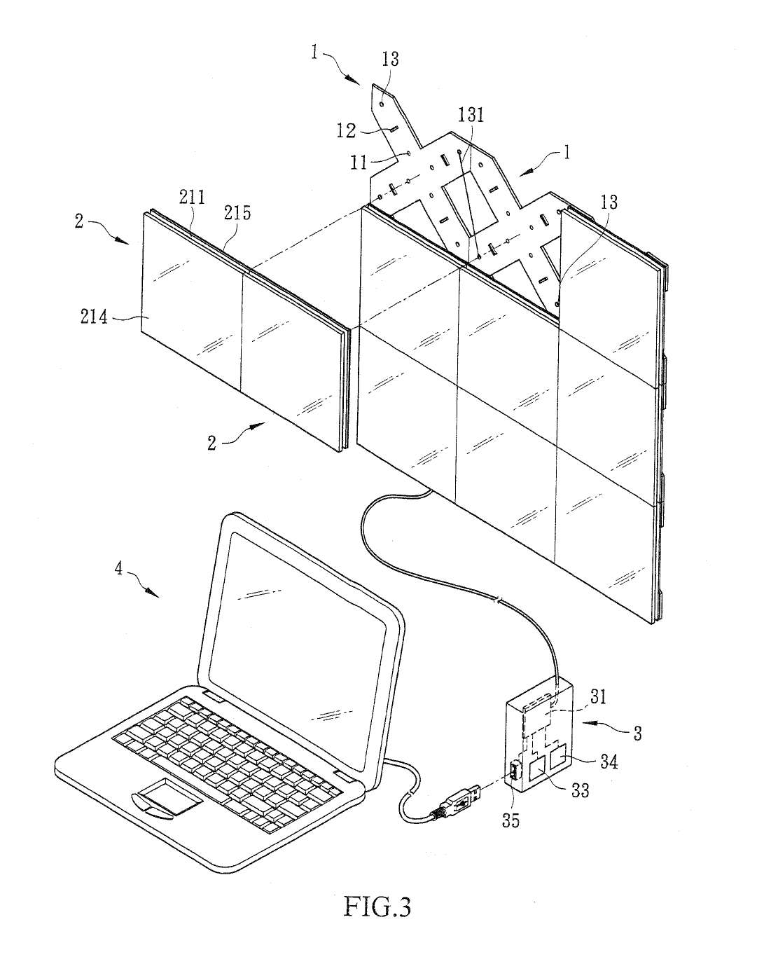

FIGS. 1, 2, and 3 are a perspective diagrams showing the outlook, components of, and installation of a luminant tile assembly according to an embodiment of the present invention. As illustrated, the luminant tile assembly contains a positioning seat 1, a luminant tile member 2, and a control device 3.

The positioning seat 1 has a number of positioning holes 11, a number of cascading elements 13, and a number of first connectors 12.

The luminant tile member 2 is positioned on the positioning seat 1 and has a layered structure 21 and a number of second connectors 22 on a side of the luminant tile member 2 electrically connected to the first connectors 12. The luminant tile 2 could be of a polygonal or circular shape. The layered structure 21 contains a protection layer 215, a light guiding plate 214, and a circuit boar 211 sandwiched between the light guiding plate 214 and the protection layer 215. The circuit board 211 is connected to the second connectors 22 and has a number of lighting elements 213 on a side of the circuit board 211. The light elements 213 could be light emitting diodes (LEDs). The light guiding plate 214 is made of a translucent and highly refractive material.

The control device is electrically connected to the layered structure 21 of the luminant tile member 2. The control device 3 contains a processing unit 31, a cable 32 connecting the processing unit and one of the cascading elements 13, an adjustment unit 33 connected to the processing unit 31, a detection nit 34 connected to the processing unit 31, and a transmission interface 35.

The luminant tile assemblies are applied as follows. Multiple positioning seats 1 are fixedly attached to the surface of a wall, floor, or ceiling by running bolts (not shown) through the positioning holes 11. The positioning seats 1 are then electrically series-connected or parallel-connected together by jumping a cable 131 between the cascading elements 13 on adjacent positioning seats 1 (one end of the cable 131 is the input end and the other end is the output end). A luminant tile member 2 is then fixed to a positioning seat 1 by matching and thereby electrically connecting the first and second connectors 12 and 22, and by applying adhesives between the luminant tile member 2 and the positioning seat 1. Then, the cable 32 of the control device 3 is electrically connected to a cascading element 13 of one of the positioning seats 1. The control device 3 is also connected to an electrical power source (not shown). To replace one of the luminant tile members 2, just remove the luminant tile member 2 by detaching the first and second connectors 12 and 22, and affix another luminant tile member 2 as described above.

The electricity from the electrical power source powers the lighting elements 213 of the luminant tile members 2 through the control device 3. By the adjustment unit 33 and the processing unit 31, the colors, on/off, and brightness can be controlled by so that various and versatile visual patterns or effects can be achieved.

Additionally, the control device 3 can be connected to a computer 4 (could be any kind of computer) or an electronic controller. The computer 4 can load a new or revised set of commands into the processing unit 31. The commands are used by the processing unit 31 to control how the lighting elements 213 of each luminant tile members 2 work so that various lighting modes and visual effects can be customized and implemented in accordance with environment or user requirement. Furthermore, the control device 3 can also be controlled by via Bluetooth, infrared, or other wireless means. Then, a user can use a notebook computer, a mobile phone, a PDA, or other portable appliances to control the control device 3.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A luminant tile assembly, comprising:
a positioning seat;
a luminant tile member electrically connected to and positioned on said positioning seat, said luminant tile member comprising a layered structure and a plurality of second connectors; and
a control device electrically connected to said layered structure of said luminant file member via said positioning seat.

2. The luminant tile assembly according to claim 1, wherein said positioning seat has a plurality of positioning holes, cascading elements, and first connectors for electrically connecting said luminant tile member.

3. The luminant tile assembly according to claim 1, wherein said luminant tile member has one of a polygonal shape and a circular shape.

4. The luminant tile assembly according to claim 1, wherein said layered structure comprises a protection layer, a light guiding plate, and a circuit board sandwiched between said protection layer and said light guiding plate; said circuit board is connected to said second connectors and has a plurality of lighting elements on a side of said circuit board facing said light guiding plate.

5. The luminant tile assembly according to claim 4, wherein said lighting elements are light emitting diodes.

6. The luminant tile assembly according to claim 4, wherein said light guiding plate is made of a highly refractive translucent material.

7. The luminant tile assembly according to claim 1, wherein said control device comprises a processing unit, an adjustment unit connected to said processing unit, a detection unit connected to said processing unit, a cable connecting processing unit to said positioning seat, and said a transmission interface connected to said processing unit.
